(19) United States
(12) Patent Application Publication
(10) Pub. No.: US 2026/0214375 A1
(43) Pub. Date: Jul. 23, 2026

(54) LOW LATENCY HEARING DEVICE AND LOW LATENCY HEARING METHOD

(71) Applicant: MEDIATEK INC., Hsinchu City (TW)

(72) Inventors: Chao-Ling HSU, Hsinchu City (TW); Yiou-Wen CHENG, Hsinchu City (TW); Kai-Sheng CHEN, Hsinchu City (TW); Chih-Chi WENG, Hsinchu City (TW); Tsung-Han LEE, Hsinchu City (TW)

(21) Appl. No.: 19/439,534

(22) Filed: Jan. 5, 2026

Related U.S. Application Data
(60) Provisional application No. 63/742,018, filed on Jan. 6, 2025.

(51) Int. Cl. H04R 1/10; G10K 11/178; H04R 25/00

(52) U.S. Cl. CPC H04R 1/1083; G10K 11/17854; H04R 25/43; H04R 25/507; G10K 2210/1081; G10K 2210/3025; G10K 2210/3028; G10K 2210/3038; G10K 2210/3047; H04R 2225/43; H04R 2460/01

(57) ABSTRACT

A low latency hearing device includes a first sound receiver and a processor. The processor includes a predictor. The first sound receiver is configured to receive an input sound signal. The processor is configured to execute following steps according to the plurality of commands of the memory: predicting a noise reduction (NR) filter by the predictor for a current frame of the sequence of frames based on a previous frame of the sequence of frames that precedes the current frame; filtering the current frame using the predicted NR filter to generate a filtered sound signal; and outputting the filtered sound signal.

### CROSS REFERENCE TO RELATED APPLICATIONS

This Application claims priority of U.S. Provisional Application No. 63/742,018, filed on Jan. 6, 2025, the entirety of which is incorporated by reference herein.

### BACKGROUND OF THE INVENTION

### Field of the Invention

The present invention relates to a hearing device and a hearing method, and, in particular, it is related to a low latency hearing device and a low latency hearing method.

### Description of the Related Art

Currently, hearing-assistive devices require the audio delay to be minimized as much as possible, while also achieving the best possible noise reduction (NR) performance (i.e., cleaner noise suppression with less speech distortion).

However, traditionally there has been a strong trade-off between latency and noise-reduction quality, making it difficult for products to excel in both aspects simultaneously.

Moreover, noise can enter the user's ears through two pathways, and both sources must be properly addressed; otherwise, if noise from either side becomes too strong, it will dominate the overall listening experience. The first pathway is physical leakage, where environmental noise directly enters the ear canal through gaps in the earphones or hearing devices. The second pathway is the sound signal reproduced by the hearing device itself; if the device amplifies background noise during audio processing, it will reduce clarity.

Physical leakage is typically mitigated in two ways: passive noise reduction, which uses materials or structural design to block noise, and active noise cancellation, which generates anti-phase sound waves to weaken external noise. As for the sound signal reproduced by the device, various noise-reduction algorithms are used to suppress non-speech background noise, ensuring that the final audio output is cleaner and easier to understand.

Therefore, a hearing device capable of effectively reducing both latency and noise is an urgently needed topic for research and development.

### BRIEF SUMMARY OF THE INVENTION

The brief summary of the invention is intended to provide a simplified overview of the present disclosure so that readers may obtain a basic understanding of its contents. The summary is not an exhaustive or comprehensive description of the disclosure, nor is it intended to identify key or essential elements of the embodiments or to limit the scope of the present disclosure.

An embodiment of the present invention provides a low latency hearing device. The low latency hearing device includes a first sound receiver and a processor. The processor includes a predictor. The first sound receiver is configured to receive an input sound signal comprising a sequence of frames. The processor is configured to execute following steps according to the plurality of commands of the memory: predicting a noise reduction (NR) filter by the predictor for a current frame of the sequence (of frames) based on a previous frame of the sequence (of frames) that precedes the current frame; filtering the current frame using the predicted NR filter to generate a filtered sound signal; and outputting the filtered sound signal.

In one embodiment, for an initial frame of the input sound signal for which there is no preceding frame, the processor is further configured to filter the initial frame using a predetermined NR filter.

In one embodiment, the processor further includes a filter converter; wherein the noise reduction (NR) filter predicted by the predictor is a prototype NR filter.

In one embodiment, the step of filtering the current frame comprises: converting, by the filter converter, the prototype NR filter into a minimum phase NR filter via a minimal phase conversion; and filtering the current frame using the minimum phase NR filter.

In one embodiment, the low latency hearing device further includes a second sound receiver and an active noise cancellation. The second sound receiver is configured to receive a leakage sound signal. The active noise cancellation reduces a volume of the leakage sound signal according to the leakage sound signal and an inverse wave data of the leakage sound signal.

In one embodiment, the low latency hearing device further includes an equalizer. The equalizer is configured to enhance the filtered sound signal. The equalizer transmits the filtered sound signal to a speaker.

In one embodiment, the low latency hearing device further includes a speech reproduce path, a noise reduction path, and a noise cancellation path. Wherein the speech reproduce path obtains the input sound signal from the first sound receiver; wherein the speech reproduce path transmits the input sound signal to a noise reduction filtering module.

In one embodiment, the noise reduction path comprises the predictor and the filter converter, and is configured to generate the noise reduction(NR) filter based on the input sound signal received from the first sound receiver; wherein the speech reproduce path comprises the noise reduction filtering module and the equalizer, operably connected in series; wherein the speech reproduce path is configured to filter the input sound signal using the minimum phase NR filter generated by the noise reduction path to produce the filtered sound signal; wherein the equalizer enhances the filtered sound signal and outputs the filtered sound signal to the speaker.

In one embodiment, the noise cancellation path is configured to: receive the input sound signal from the first sound receiver first and a leakage sound signal from the second sound receiver; generate an inverse sound wave corresponding to the leakage sound signal via the active noise cancellation module; and output the inverse sound wave to the speaker.

In one embodiment, the speech reproduce path, the noise reduction path, and the noise cancellation path are structurally and functionally distinct.

Other embodiment of the present invention provides a low latency hearing method. The low latency hearing method includes the following steps: predicting a noise reduction (NR) filter by a predictor for a current frame of a sequence based on a previous frame of the sequence that precedes the current frame; filtering the current frame using the predicted NR filter to generate a filtered sound signal; and outputting the filtered sound signal. A processor includes the predictor. A first sound receiver is configured to receive the input sound signal comprising the sequence of frames.

In one embodiment, for an initial frame of the input sound signal for which there is no preceding frame. The processor is further configured to filter the initial frame using a predetermined NR filter.

In one embodiment, the processor further comprises a filter converter; wherein the noise reduction (NR) filter predicted by the predictor is a prototype NR filter.

In one embodiment, the step of filtering the current frame comprises: converting, by the filter converter, the prototype NR filter into a minimum phase NR filter via a minimal phase conversion; and filtering the current frame using the minimum phase NR filter.

In one embodiment, a second sound receiver is configured to receive a leakage sound signal; wherein an active noise cancellation reduces a volume of the leakage sound signal according to the leakage sound signal and an inverse wave data of the leakage sound signal.

In one embodiment, an equalizer is configured to enhance the filtered sound signal; wherein the equalizer transmits the filtered sound signal to a speaker.

In one embodiment, a speech reproduce path obtains the input sound signal from the first sound receiver; wherein the speech reproduce path transmits the input sound signal to a noise reduction filtering module.

In one embodiment, a noise reduction path comprises the predictor and the filter converter, and is configured to generate the noise reduction (NR) filter based on the input sound signal received from the first sound receiver; wherein the speech reproduce path comprises the noise reduction filtering module and the equalizer, operably connected in series; wherein the speech reproduce path is configured to filter the input sound signal using the minimum phase NR filter generated by the noise reduction path to produce the filtered sound signal; wherein the equalizer enhances the filtered sound signal and outputs the filtered sound signal to the speaker.

In one embodiment, a noise cancellation path is configured to: receive the input sound signal from the first sound receiver first and a leakage sound signal from the second sound receiver; generate an inverse sound wave corresponding to the leakage sound signal via the active noise cancellation module; and output the inverse sound wave to the speaker.

In one embodiment, the speech reproduce path, the noise reduction path, and the noise cancellation path are structurally and functionally distinct.

Therefore, according to the technical content of the present disclosure, the low latency hearing device and low latency hearing method shown in the embodiment of the present disclosure can achieve the effect of effectively reducing both latency and noise is an urgently needed topic for research and development.

Other features and aspects of the present disclosure will become apparent from the following detailed description of exemplary embodiments with reference to the accompanying drawings.

After reviewing the embodiments described below, those having ordinary skill in the art will readily understand the basic spirit and other objectives of the present invention, as well as the technical means and implementation modes adopted by the present invention.

### BRIEF DESCRIPTION OF THE DRAWINGS

The views of the embodiments of the present disclosure can be better understood through the following detailed description combined with the accompanying drawings. It is worth noting that, according to standard industrial practice, some features may not be drawn to scale. In fact, to facilitate clear description, the dimensions of different features may be increased or decreased, wherein:

FIG. 1 is a block diagram of a low latency hearing device according to one embodiment of the present disclosure.

FIG. 2 is a signal timing diagram of a low latency hearing device according to one embodiment of the present disclosure.

FIG. 3 is a signal timing diagram of a low latency hearing device according to one embodiment of the present disclosure.

FIG. 4 is a usage scenario of a low latency hearing device according to one embodiment of the present disclosure.

FIG. 5 is a usage scenario of a low latency hearing device according to one embodiment of the present disclosure.

FIG. 6 is a usage scenario of a low latency hearing device according to one embodiment of the present disclosure.

FIG. 7 is a schematic flowchart of a low latency hearing method according to one embodiment of the present disclosure.

According to conventional practice, the various features and components illustrated in the drawings are depicted in a manner that best represents the specific features and components relevant to the present invention. In addition, in different figures, identical or similar reference numerals are used to denote identical or similar elements or components.

### DETAILED DESCRIPTION OF THE INVENTION

The following description is made for the purpose of illustrating the general principles of the invention and should not be taken in a limiting sense. The scope of the invention is best determined by reference to the appended claims.

In addition, in order to better explain the present disclosure, numerous specific details are provided in the following specific embodiments. It will be understood by those skilled in the art that the present disclosure may be practiced without certain specific details.

In some instances, methods, means, components and circuits that are well known to those skilled in the art are not described in detail in order to highlight the gist of the disclosure.

To make the description of the present disclosure more detailed and complete, illustrative descriptions are provided below for the implementation aspects and specific embodiments of the present case.

However, this is not the sole form of implementing or utilizing the specific embodiments of the present case. The embodiments cover the features of multiple specific embodiments as well as the method steps and their sequence for constructing and operating these specific embodiments. Nevertheless, the same or equivalent functions and sequence of steps can also be achieved using other specific embodiments.

Unless otherwise defined in this specification, the meaning of scientific and technical terms used herein is the same as commonly understood and customary by a person having ordinary skill in the art to which the present case pertains. Furthermore, without conflicting with the context, singular nouns used in this specification cover their plural forms; and plural nouns also cover their singular forms.

In some embodiments of the present disclosure, terms related to joining and connecting, such as “connect,” “interconnect,” and “bond,” unless specifically defined otherwise, may refer to situations where two structures are in direct contact, or may also refer to situations where two structures are not in direct contact, with other structures arranged between these two structures.

Moreover, these terms related to connecting and joining may also include cases where both structures are movable, or both structures are fixed. Additionally, “coupled” or “connected” as used herein may refer to two or more components being in direct physical or electrical contact with each other, or indirect physical or electrical contact with each other, and may also refer to two or more components interacting or operating with each other.

Some embodiments of the present disclosure can be understood in conjunction with the drawings, and the drawings of the embodiments of the present disclosure are also considered as part of the description of the embodiments of the present disclosure.

It should be understood that the drawings of the embodiments of the present disclosure are not drawn to the actual scale of devices and components. Furthermore, the structures and devices in the drawings are schematically illustrated to clearly illustrate the features of the embodiments of the present disclosure.

Certain terms will be used throughout the entire specification and claims of the present disclosure to refer to specific components. A person having ordinary skill in the art should understand that electronic device manufacturers may refer to the same components by different names. This document is not intended to distinguish between components that have the same function but different names. In the following specification and claims, terms such as “comprising” “containing” and “having” are open-ended terms, and therefore they should be interpreted as “containing but not limited to . . . ”.

Thus, when the terms “comprising” “containing” and/or “having” are used in the description of the present disclosure, they specify the presence of corresponding parts, regions, steps, operations, and/or elements, but do not exclude the presence of one or more corresponding parts, regions, steps, operations, and/or elements.

It should be understood that the components from multiple different embodiments can be substituted, rearranged, and combined to complete other embodiments without departing from the spirit of the present disclosure. Components between various embodiments can be arbitrarily combined and used together, as long as they do not violate the spirit of the invention or conflict with each other.

Unless otherwise defined, all terms used herein (including technical and scientific terms) have the same meaning as commonly understood by a person having ordinary skill in the art to which the present disclosure pertains. It can be understood that these terms, for example, terms defined in commonly used dictionaries, should be interpreted as having a meaning consistent with the relevant art and the background or context of the present disclosure, and should not be interpreted in an idealized or overly formal sense, unless specifically defined in the embodiments of the present disclosure.

In some embodiments, additional components may be added to the low latency hearing device of the present disclosure. In some embodiments, some components of the low latency hearing device of the present disclosure may be replaced or omitted.

In some embodiments, additional operational steps may be provided before, during, and/or after the manufacturing method of the low latency hearing device. In some embodiments, some of the described operational steps may be replaced or omitted, and the sequence of some of the described operational steps is interchangeable. Furthermore, it should be understood that some of the described steps may be replaced or deleted for other embodiments of the method. Moreover, in the present disclosure, the number and size of each component in the drawings are for illustrative purposes only, and are not intended to limit the scope of the present disclosure.

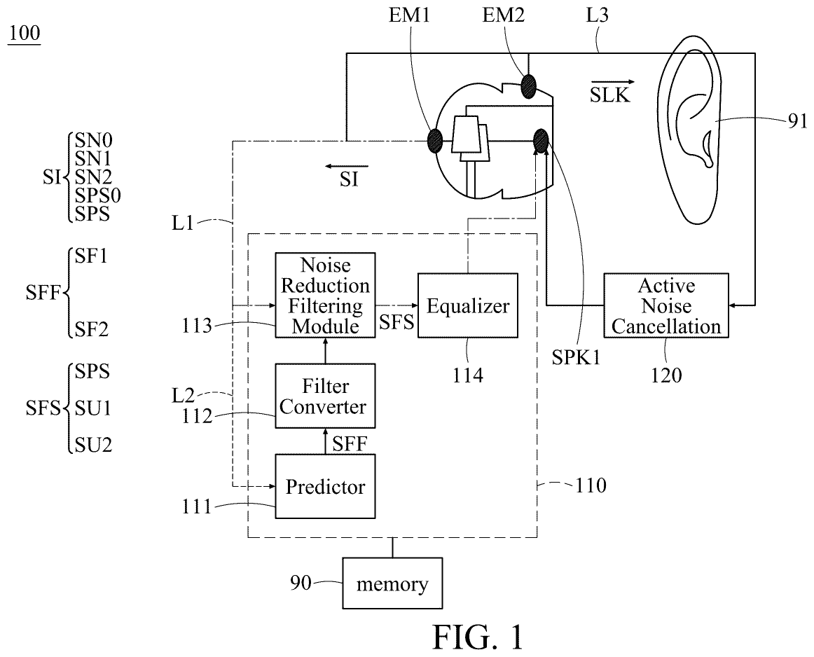

FIG. 1 is a block diagram of a low latency hearing device according to one embodiment of the present disclosure. As shown in FIG. 1, in one embodiment, the low latency hearing device 100 includes a first sound receiver EM1 and a processor 110. The processor 110 includes a predictor 111.

In some embodiments, the low latency hearing device 100 may include the first sound receiver EM1, a second sound receiver EM2, a speaker SPK1, the processor 110, an active noise cancellation 120, and a memory 90. The processor 110 may include the predictor 111, a filter converter 112, a noise reduction filtering module 113, and an equalizer 114, but the present disclosure is not limited thereto.

Regarding the connection relationship, the first sound receiver EM1 may be coupled to the speaker SPK1, and the second sound receiver EM2 may be coupled to the speaker SPK1. The predictor 111 may be coupled to the filter converter 112, the filter converter 112 may be coupled to the noise reduction filtering module 113, the noise reduction filtering module 113 may be coupled to the equalizer 114, but the present disclosure is not limited thereto.

In some embodiments, the predictor 111 (such as a future noise reduction (NR) filter prediction) may be an actual hardware component, an instruction, or software, but the present disclosure is not limited thereto.

In some embodiments, the predictor 111 (such as a future noise reduction (NR) filter prediction) may be related to any type of artificial neural network (ANN) model, any type of big data algorithm, any type of machine learning algorithm, any type of artificial intelligence (AI) algorithm, or any type of Chat Generative Pre-trained Transformer (ChatGPT) algorithm, among others. However, the present disclosure is not limited thereto.

In some embodiments, the filter converter 112 (such as a minimal phase filter conversion) may be the actual hardware component, the instruction, or the software, but the present disclosure is not limited thereto.

In some embodiments, the noise reduction filtering module 113 (such as a NR filtering) may be the actual hardware component, the instruction, or the software, but the present disclosure is not limited thereto.

In some embodiments, the equalizer 114 may be the actual hardware component, the instruction, or the software, but the present disclosure is not limited thereto.

In some embodiments, at least one of the predictor 111, the filter converter112, and the noise reduction filtering module 113 is disposed outside the processor 110, but the present disclosure is not limited thereto.

In some embodiments, the first sound receiver EM1, the second sound receiver EM2, the speaker SPK1 may be combined into an earphone. The earphone may be worn on an ear 91 of a user, but the present disclosure is not limited thereto.

In some embodiments, the processor 110 may receive a plurality of commands of the memory 90.

In some embodiments, the processor 110 may be a modem microcontroller, a system-on-chip (SoC), a microprocessor unit (MPU), a central processing unit (CPU), a graphics processing unit (GPU), a microcontroller unit (MCU), a microprocessor, a digital signal processor (DSP), a field programmable gate array (FPGA), an application-specific integrated circuit (ASIC), or a server, among others. However, the present disclosure is not limited thereto.

In some embodiments, the memory 90 may be a random-access memory (RAM), a read-only memory (ROM), a cache, a flash memory, a memory card, a hard disk (such as a cloud/network hard disk or an external hard disk), an optical disc, a USB flash drive, or a database, among others. However, the present disclosure is not limited thereto.

In some embodiments, plurality of commands of the memory 90 may be any type of programming language code, algorithm, software, or firmware, among others. However, the present disclosure is not limited thereto.

In one embodiment, the first sound receiver EM1 is configured to receive an input sound signal SI.

In one embodiment, the input sound signal SI may comprises the sequence of frames.

For example, the first sound receiver EM1 may be an out ear microphone, the input sound signal SI may include an ambient sound signal and a human voice signal, but the present disclosure is not limited thereto.

In one embodiment, the processor 110 is configured to execute following steps according to the plurality of commands of the memory 90: predicting a noise reduction (NR) filter SFF by the predictor 111 for a current frame of the sequence based on a previous frame of the sequence that precedes the current frame.

For example, the processor 110 is configured to use the predictor 111 to predict a noise reduction (NR) filter SFF for a current frame (denoted as T). This prediction is based on one or more “previous frames” that precede the current frame in time. This design provides significant flexibility, allowing the prediction algorithm to be optimized for different application scenarios and performance requirements.

It is important to note that the term “a previous frame” should not be narrowly construed to mean only the immediately preceding frame (T−1). The prediction model of the present invention can employ various combinations of previous frames for prediction, depending on design needs and computational resources, to achieve an optimal balance between noise reduction performance and processing complexity.

In one embodiment, prediction based on the immediately preceding frame. In this most direct implementation, the predictor 111 uses only the immediately preceding frame, T−1, to predict the NR filter SFF for the current frame T. The advantages of this method include simplicity of implementation and the lowest computational latency, as it only requires buffering the data of a single frame. This approach is particularly suitable for scenarios requiring an extremely fast response.

In one embodiment, prediction based on a combination of multiple preceding frames To obtain a more robust prediction, the predictor 111 may be configured to analyze a set of multiple preceding frames, for example, a set comprising frames T−1, T−2, and T−3. The predictor 111 can extract common noise features from this set or analyze trends in the noise variation over time to generate a more predictive NR filter SFF for the current frame T. This method can significantly improve noise reduction performance in complex and dynamic noise environments.

In one embodiment, prediction based on a weighted average of preceding frames. In this implementation, the predictor 111 assigns different weights to multiple preceding frames (e.g., T−1 through T−5). Typically, more recent frames are assigned higher weights, while more distant frames are assigned lower weights.

For example, the prediction might be based on 0.5*[features of Frame T−1]+0.3*[features of Frame T−2]+0.2*[features of Frame T−3]. This weighted-average approach combines the high relevance of recent data with the stability of older data, achieving a fine balance between response speed and prediction stability.

In a preferred embodiment of the present invention, the predictor 111 may be implemented as an Artificial Intelligence (AI) model, such as a machine learning model or a deep neural network (DNN). This AI-based predictor 111 is designed to learn and master the temporal correlations within complex acoustic environments, thereby achieving a more precise and intelligent prediction of the noise reduction (NR) filter.

Specifically, the implementation of this AI predictor 111 comprises two stages: a Training Phase and an Inference Phase.

During the Training Phase, the AI model is trained offline using a vast and diverse audio database. This database encompasses thousands of real-world acoustic scenarios, including but not limited to: heavy street traffic noise, crowded cafes, wind noise, and various other types of stationary and non-stationary background noises.

In some embodiments, the database is further augmented with a comprehensive collection of clean speech signals to ensure model robustness across various speakers and languages. This collection of speech signals may span a wide range of acoustic variations, including, for example, different genders, ages, languages, dialects, and accents.

To generate training data pairs, a clean speech signal is synthetically mixed with a noise signal, for instance, at a plurality of different signal-to-noise ratios (SNRs). The mixed signal serves as the input to the AI model. The corresponding ideal NR filter is then determined and used as the target output for the training, where this ideal filter is defined as the filter that, when applied to the mixed signal, optimally recovers the original clean speech signal (which serves as the ground truth).

In the training process, the model's objective is to learn the complex, non-linear mapping between input audio features (representing “past” acoustic characteristics) and their corresponding ideal NR filters (representing the optimal “future” solution). By repeatedly learning from these numerous “scenario-solution” pairs, the AI predictor 111 internalizes a predictive capability that far exceeds that of conventional algorithms.

During the Inference Phase, which occurs when the hearing device is in active use by the user, the fully trained AI predictor 111 receives feature data from one or more previous frames as its input. Based on the knowledge acquired during the training phase, the model performs a real-time, forward-looking computation to output the parameters of the NR filter suitable for the current frame.

Employing an AI model as the predictor 111 offers significant advantages. It enables the invention to dynamically adapt to rapidly changing and complex noise environments, such as when a user moves from a quiet indoor space to a noisy outdoor one. Whereas traditional rule-based algorithms struggle to cope with such non-stationary noise, the AI model, leveraging its experience learned from real-world data, can make more accurate and robust predictions.

One of ordinary skill in the art will understand that the specific architecture of the AI model is not a limitation of the present invention. Various types of neural networks, such as Recurrent Neural Networks (RNNs) or Long Short-Term Memory (LSTM) networks, which are particularly well-suited for processing time-series data, or even attention-based Transformer models, may be used to implement the predictor 111.

Therefore, any implementation that utilizes a trained AI model to predict a future noise reduction filter based on previous audio data should be considered to fall within the scope of protection of the present invention.

In one embodiment, the processor 110 is configured to execute following steps according to the plurality of commands of the memory 90: filtering the current frame of the input sound signal SI using the predicted noise reduction (NR) filter SFF to generate a filtered sound signal SFS; and outputting the filtered sound signal SFS.

For example, the processor 110 may filter or convert the input sound signal SI into the filtered sound signal SFS through the noise reduction filter SFF, the filtered sound signal SFS has a low latency relative to the input sound signal SI, but the present disclosure is not limited thereto.

For example, the filtered sound signal SFS may be a speech signal or the human voice signal, but the present disclosure is not limited thereto.

A specific operational condition arises for the initial frame of an input sound signal SI, such as upon device startup or the beginning of a new audio stream. This initial frame has no preceding frame from which the predictor can generate a prediction. To address this “cold start” condition and ensure continuous operation, the processor 110 is configured to handle this specific case. In this embodiment, the processor 110 retrieves and applies a predetermined NR filter to this initial frame. This predetermined NR filter, which may be stored in the memory 90, ensures that noise reduction is active from the very first moment of operation, preventing an unfiltered or delayed output.

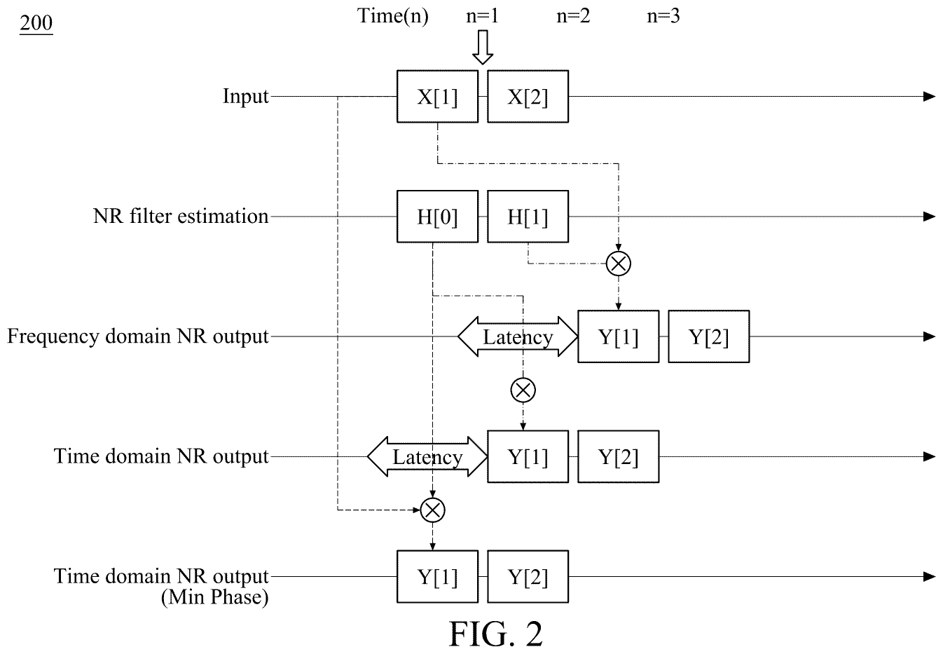

FIG. 2 is a signal timing diagram of a low latency hearing device according to one embodiment of the present disclosure. As shown in FIG. 2, in one embodiment, the signal timing diagram 200 may be configured without a prediction function. The signal timing diagram 200 may include an input terminal, a NR filter estimation terminal, a frequency domain NR output terminal, a time domain NR output terminal, and a time domain NR output (min phase) terminal.

In some embodiments, the input terminal may include the input sound signal X[1] and the input sound signal X[2], but the present disclosure is not limited thereto.

In some embodiments, the NR filter estimation terminal may include the filtering data H[0] and the filtering data H[1]. The filtering data H[0] may correspond to the input sound signal X[0], the filtering data H[1] may correspond to the input sound signal X[1], and the input sound signal X[1] is after the input sound signal X[0], but the present disclosure is not limited thereto.

In some embodiments, the frequency domain NR output terminal may include the sound signal Y[1] and the sound signal Y[2]. The processor 110 (shown in FIG. 1) may obtain the sound signal Y[1] based on the input sound signal X[1] and the filtering data H[1]. Furthermore, there may be a latency between the sound signal Y[1] and the input sound signal X[1], but the present disclosure is not limited thereto.

In some embodiments, the time domain NR output terminal may include the sound signal Y[1] and the sound signal Y[2]. The processor 110 (shown in FIG. 1) may obtain the sound signal Y[1] based on the input sound signal X[1] and the filtering data H[0]. Furthermore, there may be a latency between the sound signal Y[1] and the input sound signal X[1], but the present disclosure is not limited thereto.

In some embodiments, the time domain NR output (min phase) terminal may include the sound signal Y[1] and the sound signal Y[2]. The processor 110 (shown in FIG. 1) may obtain the sound signal Y[1] based on the input sound signal X[1] and the filtering data H[0].

In details, the processor 110 (shown in FIG. 1) may perform minimal-phase processing on the sound signal Y[1] at the time domain NR output terminal to obtain the sound signal Y[1] at the time domain NR output (min phase) terminal.

However, because the filtering data H[0] corresponds to data from the previous time instant, the resulting sound signal Y[1] at the time domain NR output (min phase) terminal is not the most ideal audio data. The sound signal Y[1] at the time domain NR output (min phase) terminal may still exhibit latency or residual environmental noise, but the present disclosure is not limited thereto.

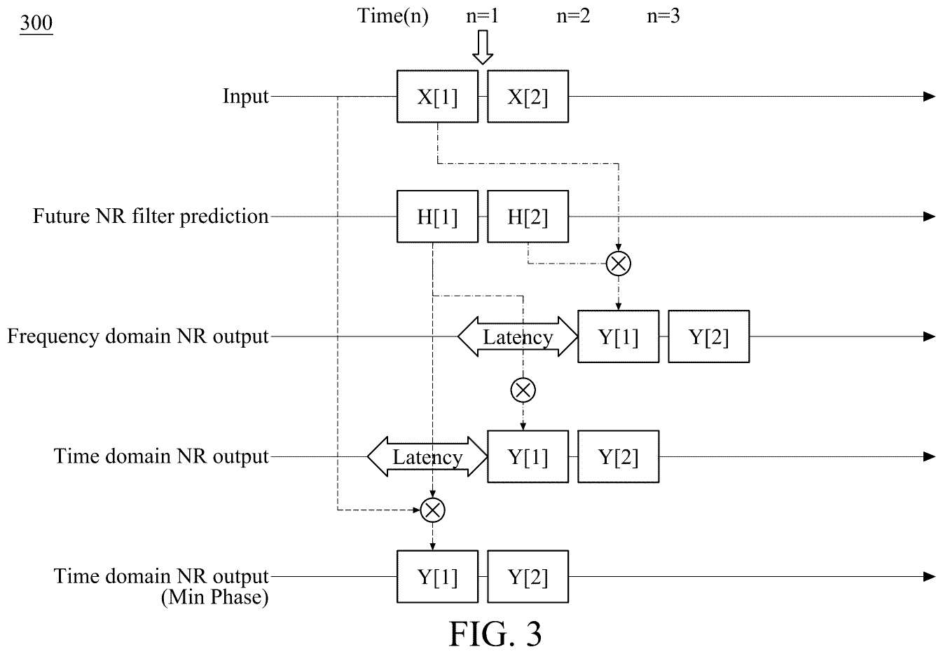

FIG. 3 is a signal timing diagram of a low latency hearing device according to one embodiment of the present disclosure. As shown in FIG. 3, in one embodiment, the signal timing diagram 300 may have the prediction function. The signal timing diagram 300 may include the input terminal, a future NR filter prediction terminal, the frequency domain NR output terminal, the time domain NR output terminal, and the time domain NR output (min phase) terminal.

In some embodiments, difference between the signal timing diagram 300 and the signal timing diagram 200 is that the NR filter estimation terminal is replaced with the future NR filter prediction terminal. The future NR filter prediction terminal may predict or obtain the current noise filtering data. In some embodiments, the input terminal may include the input sound signal X[1] and the input sound signal X[2], but the present disclosure is not limited thereto.

In some embodiments, the future NR filter prediction terminal may include the filtering data H[1] and the filtering data H[2]. The filtering data H[1] may correspond to the input sound signal X[1], the filtering data H[2] may correspond to the input sound signal X[2], and the input sound signal X[2] is after the input sound signal X[1], but the present disclosure is not limited thereto.

In some embodiments, the filtering data H[1] may be predicted from the input sound signal X[0] through the future NR filter prediction, the filtering data H[2] may be predicted from the input sound signal X[1] through the future NR filter prediction, but the present disclosure is not limited thereto.

In some embodiments, the frequency domain NR output terminal may include the sound signal Y[1] and the sound signal Y[2]. The processor 110 (shown in FIG. 1) may obtain the sound signal Y[1] based on the input sound signal X[1] and the filtering data H[2]. Furthermore, there may be a latency between the sound signal Y[1] and the input sound signal X[1], but the present disclosure is not limited thereto.

In some embodiments, the time domain NR output terminal may include the sound signal Y[1] and the sound signal Y[2]. The processor 110 (shown in FIG. 1) may obtain the sound signal Y[1] based on the input sound signal X[1] and the filtering data H[1]. Furthermore, there may be a latency between the sound signal Y[1] and the input sound signal X[1], but the present disclosure is not limited thereto.

In some embodiments, the time domain NR output (min phase) terminal may include the sound signal Y[1] and the sound signal Y[2]. The processor 110 (shown in FIG. 1) may obtain the sound signal Y[1] based on the input sound signal X[1] and the filtering data H[0].

In details, the processor 110 (shown in FIG. 1) may perform minimal-phase processing on the sound signal Y[1] at the time domain NR output terminal to obtain the sound signal Y[1] at the time domain NR output (min phase) terminal.

Furthermore, because the filtering data H[1] corresponds to data from the current time, the resulting sound signal Y[1] at the time domain NR output (min phase) terminal may be the most ideal audio data. The sound signal Y[1] at the time domain NR output (min phase) terminal may be without latency or residual environmental noise, but the present disclosure is not limited thereto.

In some embodiments, the input sound signal X[1] shown in FIG. 3 may correspond to a current frame of the input sound signal SI or the first noise sound signal SN1 shown in FIG. 1, the filtering data H[1] shown in FIG. 3 may correspond to the noise reduction filter SFF shown in FIG. 1, and the sound signal Y[1] at the time domain NR output (min phase) terminal shown in FIG. 3 may correspond to the filtered sound signal SFS or the first speech signal SPS shown in FIG. 1, but the present disclosure is not limited thereto.

In some embodiments, the sound signal Y[1] at the time domain NR output terminal shown in FIG. 3 may correspond to the first sound signal SFS, but the present disclosure is not limited thereto.

In some embodiments, the sound signal Y[1] at the frequency domain NR output terminal shown in FIG. 3 may correspond to the first sound signal SFS, but the present disclosure is not limited thereto.

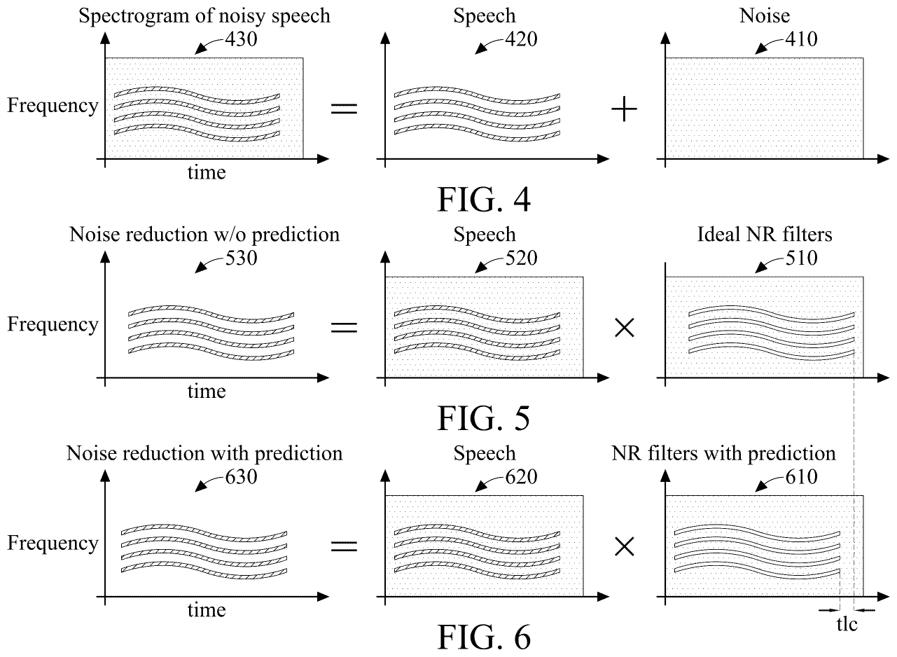

FIG. 4 is a usage scenario of a low latency hearing device according to one embodiment of the present disclosure. As shown in FIG. 4, in one embodiment, the FIG. 4 may include the sound signal 410, the speech signal 420, and the input sound signal 430.

In some embodiments, the input sound signal 430 may be composed of the sound signal 410 and the speech signal 420, but the present disclosure is not limited thereto.

In some embodiments, the sound signal 410 shown in FIG. 4 may correspond to the filtered sound signal SFS shown in FIG. 1, the speech signal 420 shown in FIG. 4 may correspond to the first speech signal SPS shown in FIG. 1, the input sound signal 430 shown in FIG. 4 may correspond to the input sound signal SI shown in FIG. 1, but the present disclosure is not limited thereto.

FIG. 5 is a usage scenario of a low latency hearing device according to one embodiment of the present disclosure. As shown in FIG. 5, in one embodiment, the FIG. 5 may include the noise filtering data 510, the input sound signal 520, and the speech signal 530.

In some embodiments, the speech signal 530 may be composed of the noise filtering data 510 and the input sound signal 520, but the present disclosure is not limited thereto.

In some embodiments, the input sound signal 520 shown in FIG. 5 may correspond to the sound signal 410 shown in FIG. 4, the speech signal 530 shown in FIG. 5 may correspond to the speech signal 420 shown in FIG. 4, but the present disclosure is not limited thereto.

In some embodiments, the noise filtering data 510 may be without the prediction function, but the present disclosure is not limited thereto.

In some embodiments, the speech signal 530 may be without the prediction function, but the present disclosure is not limited thereto.

However, because the noise filtering data 510 corresponds to data from the previous time instant and the input sound signal 520 corresponds to data from the current time, the speech signal 530 may be not the most ideal audio data. The speech signal 530 may still exhibit latency or residual environmental noise, but the present disclosure is not limited thereto.

FIG. 6 is a usage scenario of a low latency hearing device according to one embodiment of the present disclosure. As shown in FIG. 6, in one embodiment, the FIG. 6 may include the noise filtering data 610, the input sound signal 620, and the speech signal 630.

In some embodiments, the speech signal 630 may be composed of the noise filtering data 610 and the input sound signal 620, but the present disclosure is not limited thereto.

In some embodiments, the input sound signal 620 shown in FIG. 6 may correspond to the sound signal 410 shown in FIG. 4, the speech signal 630 shown in FIG. 6 may correspond to the speech signal 420 shown in FIG. 4, but the present disclosure is not limited thereto.

In some embodiments, the noise filtering data 610 shown in FIG. 6 may correspond to the noise reduction filter SFF shown in FIG. 1, the input sound signal 620 shown in FIG. 6 may correspond to the input sound signal SI shown in FIG. 1, and the speech signal 630 shown in FIG. 6 may correspond to the first speech signal SPS shown in FIG. 1, but the present disclosure is not limited thereto.

Furthermore, because each of the noise filtering data 610 and the input sound signal 620 corresponds to data from the current time, the speech signal 630 may be the most ideal audio data. The speech signal 630 may be without latency or residual environmental noise, but the present disclosure is not limited thereto.

In some embodiments, the noise filtering data 610 may be related to the prediction function, but the present disclosure is not limited thereto.

In some embodiments, there may be a latency tlc between the noise filtering data 610 shown in FIG. 6 and the noise filtering data 510 shown in FIG. 5, but the present disclosure is not limited thereto.

In some embodiments, the speech signal 630 may be related to the prediction function, but the present disclosure is not limited thereto.

Please refer to FIG. 1, FIG. 3, and FIG. 6, in one embodiment, the processor 110 further includes the noise reduction filtering module 113. The processor 110 is configured to execute following steps according to the plurality of commands of the memory 90: filtering the input sound signal SI into the first speech signal SPS by the noise reduction filtering module 113 according to the input sound signal SI and the noise reduction filter SFF.

For example, the noise reduction filtering module 113 may filter the input sound signal SI to the first speech signal SPS through the noise reduction filter SFF, but the present disclosure is not limited thereto.

In one embodiment, the processor 110 further includes a filter converter 112. the noise reduction (NR) filter SFF predicted by the predictor is a prototype NR filter. And the step of filtering the current frame comprises: converting, by the filter converter 112, the prototype NR filter into a minimum phase NR filter via a minimal phase conversion; and filtering the current frame using the minimum phase NR filter.

In one embodiment, the processor 110 further includes a filter converter 112. The processor 110 is configured to execute following steps according to the plurality of commands of the memory 90: obtaining a first-sub sound signal SU1 in frequency domain data by the filter converter 112 according to the input sound signal SI and a second noise filtering data SF2.

For example, the second noise filtering data SF2 shown in FIG. 1 may correspond to the filtering data H[2] shown in FIG. 3, the first-sub sound signal SU1 in frequency domain data shown in FIG. 1 may correspond to the sound signal Y[1] at the frequency domain NR output terminal shown in FIG. 3, but the present disclosure is not limited thereto.

In one embodiment, the second noise filtering data SF2 is after the first noise filtering data SF1.

In one embodiment, the processor 110 is configured to execute following steps according to the plurality of commands of the memory 90: obtaining a second-sub sound signal SU2 in time domain data by the filter converter 112 according to the input sound signal SI and the first noise filtering data SF1; removing a latency of the second-sub sound signal SU2 in the time domain data; and converting the second-sub sound signal SU2 in the time domain data into the filtered sound signal SFS in the time domain data by a minimal phase filter conversion.

For example, the second-sub sound signal SU2 in time domain data shown in FIG. 1 may correspond to the sound signal Y[1] at the time domain NR output terminal shown in FIG. 3, the input sound signal SI shown in FIG. 1 may correspond to input sound signal X[1] shown in FIG. 3, the first noise filtering data SF1 shown in FIG. 1 may correspond to the filtering data H[1] shown in FIG. 3, and the filtered sound signal SFS in the time domain data shown in FIG. 1 may correspond to the sound signal Y[1] at the time domain NR output (min phase) terminal shown in FIG. 3, but the present disclosure is not limited thereto.

In one embodiment, the filter converter 112 includes the minimal phase filter conversion.

For example, the filter converter 112 may be the minimal phase filter conversion, but the present disclosure is not limited thereto.

In one embodiment, the input sound signal SI includes an initial speech signal SPS0 and the first speech signal SPS. The first speech signal is after the initial speech signal.

In one embodiment, the processor 110 is configured to execute following steps according to the plurality of commands of the memory 90: obtaining the initial speech signal SPS0 of the input sound signal SI; and predicting the noise reduction filter SFF or SF1 by the predictor 111 according to the initial noise sound signal SN0 of the input sound signal SI and the initial speech signal SPS0.

For example, the predictor 111 may predict the noise reduction filter SFF or SF1 based on at least one of the initial noise sound signal SN0 of the input sound signal SI and the initial speech signal SPS0, but the present disclosure is not limited thereto.

In one embodiment, the low latency hearing device 100 further includes a second sound receiver EM2 and an active noise cancellation 120. The second sound receiver is configured to receive a leakage sound signal SLK. The active noise cancellation 120 reduces a volume of the leakage sound signal SLK according to the leakage sound signal SLK and an inverse wave data of the leakage sound signal SLK.

For example, the leakage sound signal SLK may be a sound signal in the ear 91, the active noise cancellation (ANC) 120 may mute the volume of the leakage sound signal SLK, but the present disclosure is not limited thereto.

In some embodiment, the active noise cancellation (ANC) 120 may combined a wave data of the leakage sound signal SLK and the inverse wave data of the leakage sound signal SLK to mute the volume of the leakage sound signal SLK, the phase between the wave data of the leakage sound signal SLK and the inverse wave data of the leakage sound signal SLK may be opposite, but the present disclosure is not limited thereto.

In one embodiment, the low latency hearing device 100 further includes an equalizer 114. The equalizer 114 is configured to enhance the first sound signal SFS. The equalizer 114 enhances the first speech signal SPS and transmits the first speech signal SPS to a speaker SPK1.

For example, the equalizer 114 may enhance the filtered sound signal SFS and/or the first speech signal SPS by adjusting the gain at specific built-in frequencies, thereby making the speech more prominent. However, the present disclosure is not limited thereto.

In one embodiment, the low latency hearing device 100 further includes a speech reproduce path L1, a noise reduction path L2, and a noise cancellation path L3.

For example, the speech reproduce path L1, the noise reduction path L2, and the noise cancellation path L3 may be different from each other, but the present disclosure is not limited thereto.

In one embodiment, the speech reproduce path L1 obtains the input sound signal SI from the first sound receiver EM1. The speech reproduce path L1 transmits the input sound signal SI to the noise reduction filtering module 113.

In one embodiment, the noise reduction path L2 obtains the initial noise sound signal SN0 of the input sound signal SI and the first noise sound signal SN1 of the input sound signal SI from the first sound receiver EM1.

In one embodiment, the noise reduction path L2 obtains the noise reduction filter SFF or SF1 and the filtered sound signal SFS in the time domain data through the predictor 111, the filter converter 112, and the noise reduction filtering module 113.

In one embodiment, the speech reproduce path L1 transmits the first speech signal SPS through the noise reduction filtering module 113 and the equalizer 114. The speech reproduce path L1 outputs the first speech signal SPS to the speaker SPK1.

In one embodiment, the noise cancellation path L3 obtains the input sound signal SI and the leakage sound signal SLK from the first sound receiver EM1 and the second sound receiver EM2.

In one embodiment, the noise cancellation path L3 transmits the leakage sound signal SLK and the inverse wave data of the leakage sound signal SLK to the speaker SPK1 through the active noise cancellation 120.

In one embodiment, the speech reproduce path L1, the noise reduction path L2, and the noise cancellation path L3 are different from each other.

In some embodiments, the speech reproduce path L1 may directly affect the latency from external speech to what the user hears, and it needs to be as short as possible.

In the proposed architecture, the audio from the external microphone to NR filtering, equalization (EQ), and then output through the speaker has no additional buffering or latency, ensuring the lowest possible latency.

The NR filtering here is performed based on the filter predicted by the NR predictor, which itself has no latency. The prediction of the NR filter and the filtering process are handled separately to avoid the propagation of latency, but the present disclosure is not limited thereto.

In some embodiments, the noise reduction path L2 may use model training (such as AI model . . . etc.) to predict the NR filter at the next time frame, that the NR algorithm doesn't need to determine the NR filter based on the currently observed signal.

The noise reduction path L2 may convert the NR filter into a time domain minimal phase filter to minimize latency as much as possible, but the present disclosure is not limited thereto.

In some embodiments, regarding the noise cancellation path L3, ANC is a technology used to reduce physical leakage. It does not affect the latency of the speech reproduce path L1 itself but can prevent physical leakage from dominating the listening experience, which would otherwise make the NR effect inaudible, but the present disclosure is not limited thereto.

In some embodiments, the low latency hearing device 100 may overcome the trade-off between latency and noise reduction effectiveness by combining ultra-low latency hardware filter circuits with predictive noise reduction filters.

Additionally, it utilizes ANC to eliminate physical leakage and the comb filter effect, effectively enhancing the clarity of external speech heard by the user, but the present disclosure is not limited thereto.

Therefore, the sound signal received by the in-ear microphone (such as the second sound receiver EM2) is the total sound actually heard inside the ear, and it is fed back to the ANC path to ensure effective noise cancellation and to eliminate the comb-filtering effect caused by phase differences between the physical leakage and the reproduced sound signal, but the present disclosure is not limited thereto.

In some embodiments, in the frequency domain, noise reduction is performed after converting the input audio signal into a frequency-domain spectrum (e.g., via Fast Fourier Transform (FFT)), which is a more commonly adopted approach. This method generally achieves better noise-reduction performance. However, it also introduces higher latency and requires a trade-off between time resolution and frequency resolution. However, the present disclosure is not limited thereto.

In some embodiments, in the time domain, noise reduction is applied directly to the audio signal without converting it into another representation. This approach offers the advantage of lower latency, making it suitable for real-time applications. Furthermore, it generally provides less effective noise-reduction performance compared to frequency-domain methods. However, the present disclosure is not limited thereto.

In some embodiments, regarding of the conventional techniques, a primary goal of modern hearing devices is to help users understand speech more clearly in noisy environments.

To achieve this, a high-quality hearing device must effectively balance several factors: latency, which should be as low as possible; noise reduction (NR), which should remove background noise cleanly while preserving speech quality; and physical leakage, which should be minimized to prevent external noise from entering the ear.

Furthermore, in practice, there is a significant trade-off between low latency and strong NR performance, making it challenging for existing products to excel in both areas at the same time. However, the present disclosure is not limited thereto.

In some embodiments, regarding of the conventional techniques, noise may enter a user's ears through two main pathways, both of which must be properly managed; otherwise, excessive noise from either source can dominate the listening experience.

The first pathway is physical leakage, where environmental noise enters directly through gaps in the hearing device. Physical leakage is typically addressed in two ways: passive noise reduction, which physically blocks noise using materials or structural designs, and active noise reduction, which uses signal processing to generate an inverse wave that destructively interferes with the noise, reducing its volume.

The second pathway involves the sound signals reproduced by the hearing device itself, where background noise may be amplified along with speech. For these signals, noise reduction algorithms are employed to suppress non-speech noise and minimize interference, ensuring clearer audio for the user.

However, physical leakage and the reproduced sound signals can interact with each other due to phase differences, often creating a comb filter effect that negatively impacts the listening experience.

Several solutions can mitigate this issue: increasing the volume difference between the two sources, reducing the latency between physical leakage and reproduced signals, and employing active noise cancellation (ANC) to further reduce physical leakage.

By carefully addressing both pathways and their interactions, hearing devices can provide a cleaner, more natural listening experience for the user, but the present disclosure is not limited thereto.

In some embodiments, the primary distinction and advantage of the present ultra-low-latency noise-reduction hearing system (such as the low latency hearing device 100), compared with conventional technologies, lie in its ability to overcome the long-standing trade-off between latency and noise-reduction (NR) performance—a challenge that existing products on the market struggle to address simultaneously. Traditional NR approaches generally fall into two categories: frequency-domain processing, which provides stronger noise-suppression performance but introduces significant latency; and time-domain processing, which achieves low latency but delivers weaker NR effectiveness.

The present ultra-low-latency noise-reduction hearing system (such as the low latency hearing device 100) may combine an ultra-low-latency hardware filtering circuit with a predictive noise-reduction filter (such as the noise reduction filtering module 113) to obtain the strengths of both approaches. From the moment the external microphone (such as the first sound receiver EM1) captures audio, through NR filtering and equalization (EQ), to the final speaker output, the speech-reproduction path operates without additional buffering or processing delay, thereby achieving the lowest possible latency.

In terms of noise-reduction functionality, the present ultra-low-latency noise-reduction hearing system (such as the low latency hearing device 100) may do not rely on conventional filter estimation based on the current signal—an approach that inevitably uses filtering data derived from the previous time frame and thus weakens NR performance. Instead, the present ultra-low-latency noise-reduction hearing system (such as the low latency hearing device 100) may utilize a trained model (such as the artificial intelligence (AI) model) to predict the noise-reduction filter required for the next time frame and converts the predicted filter into a time-domain minimal-phase filter to minimize latency and prevent delay propagation.

Furthermore, the present ultra-low-latency noise-reduction hearing system (such as the low latency hearing device 100) may integrate active noise cancellation (ANC) to suppress physical leakage and mitigate comb-filter effects caused by phase differences between leakage noise and the reproduced sound signal.

As a result, the clarity of external speech perceived by the user is significantly enhanced, physical leakage is prevented from dominating the listening experience, and the NR effect becomes reliably perceptible to the user, but the present disclosure is not limited thereto.

In some embodiments, in detail, the primary technical achievement of the present ultra-low-latency noise-reduction hearing system (such as the low latency hearing device 100) is that it provides a comprehensive solution to the inherent trade-off between latency and noise reduction (NR) performance in hearing devices.

In terms of latency, the present ultra-low-latency noise-reduction hearing system (such as the low latency hearing device 100) may ensure that the entire speech reproduction path—from capturing external speech, through noise reduction and equalization (EQ), to outputting sound through the speaker—introduces no additional buffering or processing delay, thereby achieving the lowest possible latency.

Regarding noise reduction performance, the present ultra-low-latency noise-reduction hearing system (such as the low latency hearing device 100) may employ a model-based approach (such as the AI model) to predict the noise reduction filter required for the next time frame, effectively avoiding the degradation in NR performance caused by traditional methods that rely on estimating filters from the current signal. Furthermore, the predicted filter is converted into a minimum-phase filter (such as the filter converter 112 and/or the noise reduction filtering module 113) in the time domain, which further minimizes latency and maintains consistent auditory perception.

For handling noise interference, the invention integrates active noise cancellation (ANC) to eliminate physical leakage while suppressing the comb filter effect arising from phase differences between the leakage sound and the reproduced sound signal.

Through the combined use of NR prediction (such as the predictor 111), minimum-phase filtering (such as the filter converter 112 and/or the noise reduction filtering module 113), and ANC (such as the active noise cancellation 120), the present ultra-low-latency noise-reduction hearing system (such as the low latency hearing device 100) may prevent physical leakage from dominating the listening experience and significantly enhances the clarity of external speech, ensuring that the noise reduction benefits are clearly perceived by the user, but the present disclosure is not limited thereto.

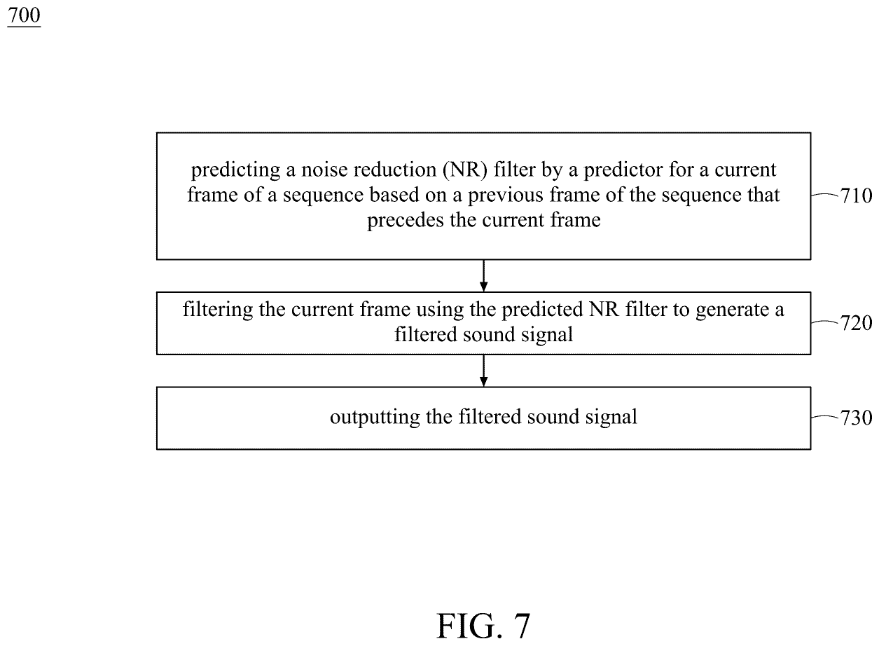

FIG. 7 is a schematic flowchart of a low latency hearing method according to one embodiment of the present disclosure. As shown in FIG. 7, in one embodiment, the low latency hearing method 700 may include the plurality of steps 710 to 730.

Please refer to FIG. 1, FIG. 3, FIG. 6, and FIG. 7, the following provides a detailed description of the plurality of steps 710 to 730.

In the step 710, predicting a noise reduction (NR) filter by a predictor for a current frame of a sequence based on a previous frame of the sequence that precedes the current frame.

In one embodiment, the processor 110 may predict the noise reduction (NR) filter SFF by the predictor 111 for the current frame of the sequence based on the previous frame of the sequence that precedes the current frame.

In the step 720, filtering the current frame using the predicted NR filter to generate a filtered sound signal.

In one embodiment, the processor 110 may filter the current frame using the predicted NR filter to generate a filtered sound signal SFS.

In the step 730, outputting the filtered sound signal.

In one embodiment, the processor 110 may output the filtered sound signal SFS.

In one embodiment, the processor 110 includes the predictor 111. The first sound receiver EM1 is configured to receive the input sound signal SI comprising the sequence of frames.

It should be understood that the above steps need not be performed sequentially, and each feature of the embodiments shown in figure1 to FIG. 6 may be applied to the low latency hearing method 700 illustrated in FIG. 7.

In one embodiment, the low latency hearing method 700 further includes the following steps: filtering the input sound signal SI into the first speech signal SPS by a noise reduction filtering module 113 according to the input sound signal SI and the noise reduction filter SFF or SF1. The processor 110 further includes the noise reduction filtering module 113.

In one embodiment, the low latency hearing method 700 further includes the following steps: obtaining a first-sub sound signal SU1 in frequency domain data by a filter converter 112 according to the input sound signal SI and a second noise filtering data SF2.

In one embodiment, the second noise filtering data SF2 is after the first noise filtering data SF1. The processor 110 further includes the filter converter 112.

In one embodiment, the low latency hearing method 700 further includes the following steps: obtaining a second-sub sound signal SU2 in time domain data by the filter converter 112 according to the input sound signal SI and the noise reduction filter SFF or SF1; removing a latency of the second-sub sound signal SU2 in the time domain data; and converting the second-sub sound signal SU2 in the time domain data into the filtered sound signal SFS in the time domain data by a minimal phase filter conversion.

In one embodiment, the filter converter 112 includes the minimal phase filter conversion.

In one embodiment, the low latency hearing method 700 further includes the following steps: obtaining an initial speech signal SPS0 of the input sound signal SI; and predicting the noise reduction filter SFF or SF1 by the predictor 111 according to the initial noise sound signal SN0 of the input sound signal SI and the initial speech signal SPS0.

In one embodiment, the input sound signal SI includes the initial speech signal SPS0 and the first speech signal SPS.

In one embodiment, the second sound receiver is configured to receive a leakage sound signal SLK.

In one embodiment, the active noise cancellation 120 reduces the volume of the leakage sound signal SLK according to the leakage sound signal SLK and an inverse wave data of the leakage sound signal SLK.

In one embodiment, the equalizer 114 is configured to enhance the first sound signal SFS. The equalizer 114 enhances the first speech signal SPS and transmits the first speech signal SPS to the speaker SPK1.

In one embodiment, the speech reproduce path L1 obtains the input sound signal SI from the first sound receiver EM1. The speech reproduce path L1 transmits the input sound signal SI to the noise reduction filtering module 113.

In one embodiment, the noise reduction path L2 obtains the initial noise sound signal SN0 of the input sound signal SI and the first noise sound signal SN1 of the input sound signal SI from the first sound receiver EM1.

In one embodiment, the noise reduction path L2 obtains the noise reduction filter SFF or SF1 and the filtered sound signal SFS in the time domain data through the predictor 111, the filter converter 112, and the noise reduction filtering module 113.

In one embodiment, the speech reproduce path L1 transmits the first speech signal SPS through the noise reduction filtering module 113 and the equalizer 114. The speech reproduce path L1 outputs the first speech signal SPS to the speaker SPK1.

In one embodiment, the noise cancellation path L3 obtains the input sound signal SI and the leakage sound signal SLK from the first sound receiver EM1 and the second sound receiver EM2.

In one embodiment, the noise cancellation path L3 transmits the inverse wave data of the leakage sound signal SLK to the speaker SPK1 through the active noise cancellation 120.

In one embodiment, the speech reproduce path L1, the noise reduction path L2, and the noise cancellation path L3 are different from each other.

In one embodiment, for an initial frame of the input sound signal SI for which there is no preceding frame. The processor 110 is further configured to filter the initial frame using a predetermined NR filter.

In one embodiment, the processor 110 further comprises a filter converter. The noise reduction (NR) filter SFF predicted by the predictor is a prototype NR filter.

In one embodiment, the step of filtering the current frame comprises: converting, by the filter converter 112, the prototype NR filter into a minimum phase NR filter via a minimal phase conversion; and filtering the current frame using the minimum phase NR filter.

In one embodiment, a second sound receiver EM2 is configured to receive a leakage sound signal SLK. An active noise cancellation 120 reduces a volume of the leakage sound signal SLK according to the leakage sound signal SLK and an inverse wave data of the leakage sound signal SLK.

In one embodiment, an equalizer is configured to enhance the filtered sound signal SFS. The equalizer transmits the filtered sound signal SFS to a speaker SPK1.

In one embodiment, a speech reproduce path L1 obtains the input sound signal SI from the first sound receiver EM1. The speech reproduce path L1 transmits the input sound signal SI to a noise reduction filtering module 113.

In one embodiment, a noise reduction path L2 comprises the predictor 111 and the filter converter 112, and is configured to generate the noise reduction (NR) filter based on the input sound signal SI received from the first sound receiver EM1. The speech reproduce path L1 comprises the noise reduction filtering module 113 and the equalizer 114, operably connected in series. The speech reproduce path L1 is configured to filter the input sound signal SI using the minimum phase NR filter generated by the noise reduction path L2 to produce the filtered sound signal SFS. The equalizer 114 enhances the filtered sound signal SFS and outputs the filtered sound signal SFS to the speaker SPK1.

In one embodiment, a noise cancellation path L2 is configured to: receive the input sound signal SI from the first sound receiver EM1 first and a leakage sound signal SLK from the second sound receiver EM2; generate an inverse sound wave corresponding to the leakage sound signal SLK via the active noise cancellation module; and output the inverse sound wave to the speaker SPK1.

In some embodiments, the active noise cancellation module may correspond to the active noise cancellation 120, but the present disclosure is not limited thereto.

In some embodiments, the active noise cancellation module may be the active noise cancellation 120, but the present disclosure is not limited thereto.

In one embodiment, the speech reproduce path L1, the noise reduction path L2, and the noise cancellation path L3 are structurally and functionally distinct.

In some embodiments, the low latency hearing method 700 may be implemented by the low latency hearing device 100, but the present disclosure is not limited thereto. In some embodiments, the low latency hearing method 700 method may be implemented by a non-transitory computer-readable storage medium, but the present disclosure is not limited thereto. In some embodiments, the low latency hearing method 700 method may be implemented by other systems or servers, but the present disclosure is not limited thereto.

Therefore, according to the technical content of the present disclosure, the low latency hearing device and low latency hearing method shown in the embodiment of the present disclosure can achieve the effect of effectively reducing both latency and noise is an urgently needed topic for research and development.

Furthermore, the low latency hearing device 100 and the low latency hearing device 700 shown in the embodiment may overcome the trade-off between latency and noise reduction effectiveness by combining ultra-low latency hardware filter circuits with predictive noise reduction filters.

Additionally, it utilizes ANC to eliminate physical leakage and the comb filter effect, effectively enhancing the clarity of external speech heard by the user, but the present disclosure is not limited thereto.

In detail, the primary technical achievement of the low latency hearing device 100 and the low latency hearing device 700 shown in the embodiment is that it provides a comprehensive solution to the inherent trade-off between latency and noise reduction (NR) performance in hearing devices.

In terms of latency, the low latency hearing device 100 and the low latency hearing device 700 may ensure that the entire speech reproduction path—from capturing external speech, through noise reduction and equalization (EQ), to outputting sound through the speaker—introduces no additional buffering or processing delay, thereby achieving the lowest possible latency.

Regarding noise reduction performance, the low latency hearing device 100 and the low latency hearing device 700 may employ a model-based approach (such as the AI model) to predict the noise reduction filter required for the next time frame, effectively avoiding the degradation in NR performance caused by traditional methods that rely on estimating filters from the current signal. Furthermore, the predicted filter is converted into a minimum-phase filter (such as the filter converter 112 and/or the noise reduction filtering module 113) in the time domain, which further minimizes latency and maintains consistent auditory perception.

For handling noise interference, the low latency hearing device 100 and the low latency hearing device 700 shown in the embodiment integrates active noise cancellation (ANC) to eliminate physical leakage while suppressing the comb filter effect arising from phase differences between the leakage sound and the reproduced sound signal.

Through the combined use of NR prediction (such as the predictor 111), minimum-phase filtering (such as the filter converter 112 and/or the noise reduction filtering module 113), and ANC (such as the active noise cancellation 120), the low latency hearing device 100 and the low latency hearing device 700 may prevent physical leakage from dominating the listening experience and significantly enhances the clarity of external speech, ensuring that the noise reduction benefits are clearly perceived by the user.

In addition, it should be understood that the ordinal terms such as “first” “second” and the like used in the specification and the claims are employed to modify elements and are not intended to indicate any temporal order of the element(s), nor do they imply any sequence between elements or any sequence in a manufacturing process. The sole purpose of these ordinals is to clearly distinguish elements having similar names from one another. The same terms used in the specification and in the claims need not correspond; for example, an element referred to as a first element in the specification may be referred to as a second element in the claims.

The scope of protection of the present disclosure is not limited to the processes, machines, manufactures, compositions of matter, devices, methods, and steps described in the specific embodiments of the specification. Any person of ordinary skill in the art will understand from the teachings of the present disclosure that existing or future-developed processes, machines, manufactures, compositions of matter, devices, methods, and steps may be used, so long as they can perform substantially the same function or achieve substantially the same result as those in the embodiments described herein.

Accordingly, the scope of the present disclosure encompasses such processes, machines, manufactures, compositions of matter, devices, methods, and steps. Any embodiment or claim of the present disclosure does not need to achieve all of the objectives, advantages, and/or features disclosed herein.

The foregoing has outlined several embodiments to assist those of ordinary skill in the art in better understanding the concepts of the embodiments of the present disclosure. It should be understood by those of ordinary skill in the art that, based on the embodiments of the present disclosure, they may design or modify other processes and structures to achieve the same objectives and/or advantages as the embodiments described herein.

It should also be understood that such equivalent processes and structures do not depart from the spirit and scope of the present disclosure, and that various changes, substitutions, and alterations can be made without departing from the spirit and scope of the present disclosure.

While the invention has been described by way of example and in terms of the preferred embodiments, it should be understood that the invention is not limited to the disclosed embodiments. On the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A low latency hearing device, comprising:
a first sound receiver, configured to receive an input sound signal comprising a sequence of frames; and
a processor, comprising:
a predictor;
wherein the processor is configured to execute following steps according to a plurality of commands of a memory:
predicting a noise reduction (NR) filter by the predictor for a current frame of the sequence based on a previous frame of the sequence that precedes the current frame;
filtering the current frame using the predicted NR filter to generate a filtered sound signal; and
outputting the filtered sound signal.

2. The low latency hearing device as claimed in claim 1, wherein
for an initial frame of the input sound signal for which there is no preceding frame;
wherein the processor is further configured to filter the initial frame using a predetermined NR filter.

3. The low latency hearing device as claimed in claim 1, wherein
the processor further comprises a filter converter;
wherein the noise reduction (NR) filter predicted by the predictor is a prototype NR filter.

4. The low latency hearing device as claimed in claim 3, wherein
the step of filtering the current frame comprises:
converting, by the filter converter, the prototype NR filter into a minimum phase NR filter via a minimal phase conversion; and
filtering the current frame using the minimum phase NR filter.

5. The low latency hearing device as claimed in claim 4, further comprising:
a second sound receiver, configure to receive a leakage sound signal; and
an active noise cancellation;
wherein the active noise cancellation reduces a volume of the leakage sound signal according to the leakage sound signal and an inverse wave data of the leakage sound signal.

6. The low latency hearing device as claimed in claim 5, further comprising:
an equalizer, configured to enhance the filtered sound signal,
and transmits the filtered sound signal to a speaker.

7. The low latency hearing device as claimed in claim 6, further comprising:
a speech reproduce path;
a noise reduction path; and
a noise cancellation path;
wherein the speech reproduce path obtains the input sound signal from the first sound receiver;
wherein the speech reproduce path transmits the input sound signal to a noise reduction filtering module.

8. The low latency hearing device as claimed in claim 7, wherein
the noise reduction path comprises the predictor and the filter converter, and is configured to generate the noise reduction(NR) filter based on the input sound signal received from the first sound receiver;
wherein the speech reproduce path comprises the noise reduction filtering module and the equalizer, operably connected in series;
wherein the speech reproduce path is configured to filter the input sound signal using the minimum phase NR filter generated by the noise reduction path to produce the filtered sound signal;
wherein the equalizer enhances the filtered sound signal and outputs the filtered sound signal to the speaker.

9. The low latency hearing device as claimed in claim 8, wherein
the noise cancellation path is configured to:
receive the input sound signal from the first sound receiver first and a leakage sound signal from the second sound receiver;
generate an inverse sound wave corresponding to the leakage sound signal via an active noise cancellation module; and
output the inverse sound wave to the speaker.

10. The low latency hearing device as claimed in claim 9, wherein
the speech reproduce path, the noise reduction path, and the noise cancellation path are structurally and functionally distinct.

11. A low latency hearing method, comprising:
predicting a noise reduction (NR) filter by a predictor for a current frame of a sequence based on a previous frame of the sequence that precedes the current frame;
filtering the current frame using the predicted NR filter to generate a filtered sound signal; and
outputting the filtered sound signal;
wherein a processor comprises the predictor;
wherein a first sound receiver is configured to receive an input sound signal comprising the sequence of frames.

12. The low latency hearing method as claimed in claim 11, wherein
for an initial frame of the input sound signal for which there is no preceding frame;
wherein the processor is further configured to filter the initial frame using a predetermined NR filter.

13. The low latency hearing method as claimed in claim 11, wherein
the processor further comprises a filter converter;
wherein the noise reduction (NR) filter predicted by the predictor is a prototype NR filter.

14. The low latency hearing method as claimed in claim 13, wherein
the step of filtering the current frame comprises:
converting, by the filter converter, the prototype NR filter into a minimum phase NR filter via a minimal phase conversion; and
filtering the current frame using the minimum phase NR filter.

15. The low latency hearing method as claimed in claim 14, wherein
a second sound receiver is configured to receive a leakage sound signal;
wherein an active noise cancellation reduces a volume of the leakage sound signal according to the leakage sound signal and an inverse wave data of the leakage sound signal.

16. The low latency hearing method as claimed in claim 15, wherein
an equalizer is configured to enhance the filtered sound signal;
wherein the equalizer transmits the filtered sound signal to a speaker.

17. The low latency hearing method as claimed in claim 16, wherein
a speech reproduce path obtains the input sound signal from the first sound receiver;
wherein the speech reproduce path transmits the input sound signal to a noise reduction filtering module.

18. The low latency hearing method as claimed in claim 17, wherein
a noise reduction path comprises the predictor and the filter converter, and is configured to generate the noise reduction (NR) filter based on the input sound signal received from the first sound receiver;
wherein the speech reproduce path comprises the noise reduction filtering module and the equalizer, operably connected in series;
wherein the speech reproduce path is configured to filter the input sound signal using the minimum phase NR filter generated by the noise reduction path to produce the filtered sound signal;
wherein the equalizer enhances the filtered sound signal and outputs the filtered sound signal to the speaker.

19. The low latency hearing method as claimed in claim 18, wherein
a noise cancellation path is configured to:
receive the input sound signal from the first sound receiver first and a leakage sound signal from the second sound receiver;
generate an inverse sound wave corresponding to the leakage sound signal via an active noise cancellation module; and
output the inverse sound wave to the speaker.

20. The low latency hearing method as claimed in claim 19, wherein
the speech reproduce path, the noise reduction path, and the noise cancellation path are structurally and functionally distinct.
